(19) United States
(12) Patent Application Publication
(10) Pub. No.: US 2006/0128179 A1
(43) Pub. Date: Jun. 15, 2006

(54) DISPLAY DEVICE STRUCTURE WITH CIRCUIT BOARD SECURED TO DISPLAY PANEL AND METHOD OF SECURING CIRCUIT BOARD TO PANEL THEREOF

(75) Inventor: Chi-Mi Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Lite-On Technology Corporation

(21) Appl. No.: 11/030,769

(22) Filed: Jan. 7, 2005

(30) Foreign Application Priority Data
Dec. 14, 2004 (TW) 93138716

(51) Int. Cl. H01R 12/00

(52) U.S. Cl. 439/76.1

(57) ABSTRACT

A display and a method of coupling a circuit board to a panel of the display. A frame is secured to the panel, and the circuit board is coupled to the frame in such a manner that a part of the fire is positioned between the circuit board and the panel. A shield element is secured to the frame to shield the circuit board.

### BACKGROUND

The invention relates to a method of securing a circuit board to a panel of a display, and in particular to a method of securing a circuit board that facilitates maintenance of the circuit board.

In general, in a display, particularly in a liquid crystal display, a circuit board is disposed on the back of a panel to receive power or image signals. A conventional method of securing a circuit board to a panel is shown in FIGS. 1a and 1b. Circuit boards 10 and 20 are fixed on a frame 30 by bolts with electronic elements on the circuit boards facing the frame 30, and the frame 30 having circuit boards 10 and 20 attached thereon is mounted to the panel 40. Circuit boards 10 and 20 are located between the frame 30 and the panel 40 and shielded by the frame 30. If maintenance or replacement of the electronic elements on the circuit boards 10 or 20 is desired, the panel 40 must be detached from the display at first, the frame 30 must be detached from the panel 40, and the circuit boards 10 and 20 must be detached from the frame 30 so as to access the electronic elements on the circuit boards 10 and 20. This dissembling method is complicated and maintenance or part replacement is time consuming. In addition, because the locations of power and/or signal connectors on the circuit board are varied based on different designs, various frame designs are required.

### SUMMARY

A display according to the invention comprises a panel, a frame and a circuit board. The frame with at least one circuit board attached thereon is mounted to the panel, wherein a part of the frame is located between the panel and the circuit board. Thus maintenance of the electronic components on the circuit board can be performed from the back of the panel directly without dissembling the frame and the circuit board from the panel.

The frame comprises a first body and a second body separated from the first body by a predetermined distance, and the circuit board is either attached only to the first body, or to both the first and second bodies. Even though the locations of the power connector and signal connector may vary, some part of the frame can still be used as long as the panel size is the same.

The frame further comprises a third body connected to the first body, and the circuit board is secured to the third body. The third body can either be soldered to the first body, or integrally formed with the first body.

### BRIEF DESCRIPTION OF THE DRAWINGS

The invention can be more fully understood by reading the subsequent detailed description and examples with references made to the accompanying drawings, wherein:

FIGS. 1a and 1b are schematic views of a conventional method of securing a circuit board to a panel; and

FIGS. 2a, 2b and 2c are schematic views depicting a method of securing a circuit board to a panel according to an embodiment of the invention.

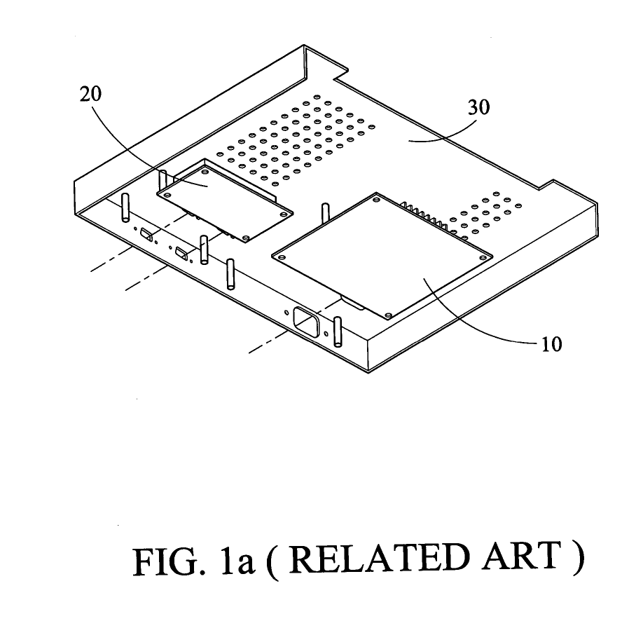

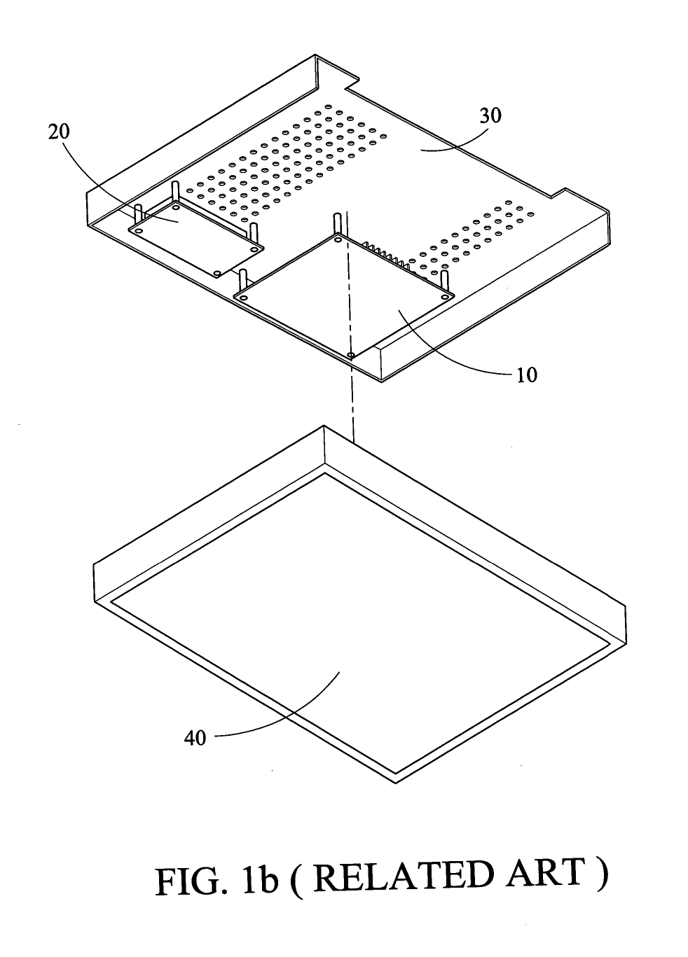

### DETAILED DESCRIPTION

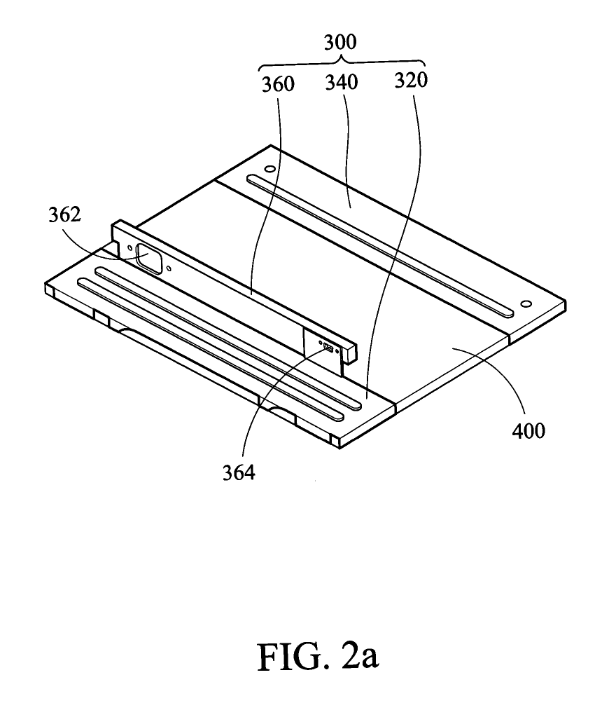

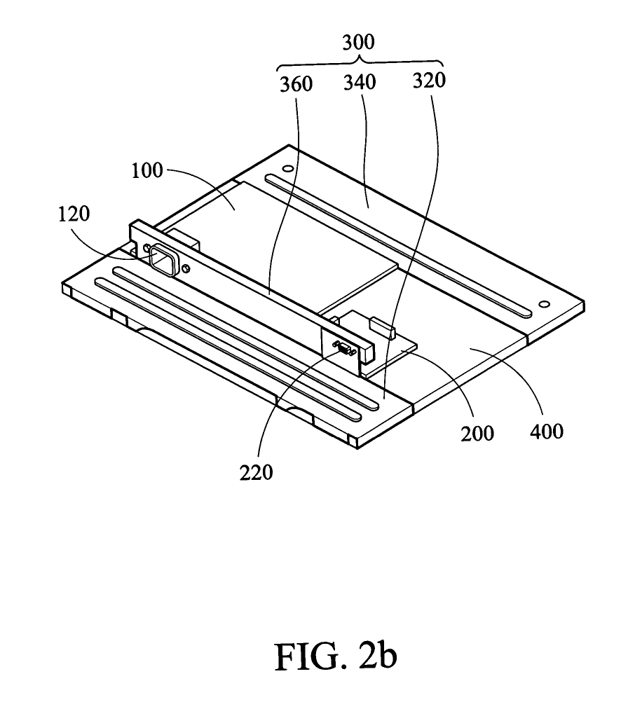

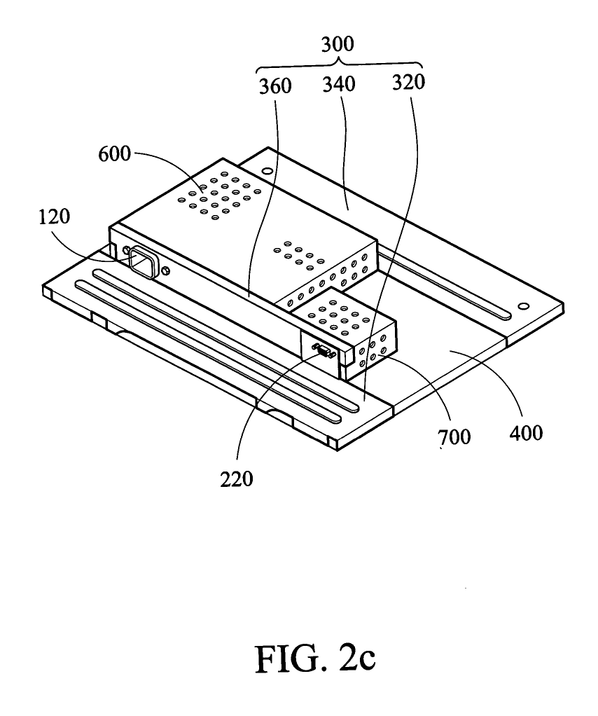

FIGS. 2a, 2b and 2c show a method of securing a circuit board to a panel according to an embodiment of the invention. Reference numeral 400 in the figure represents a panel of a display. For simplicity, depiction of other parts of the display is omitted.

A frame 300 is provided to have circuit boards 100 and 200 mounted to the panel 400. The frame 300 comprises a first body 320, a second body 340 and a third body 360. The first and second bodies 320 and 340 are mounted on two opposite sides of the panel 400 with a predetermined distance therebetween. The third body 360 is connected to the first body 320 (for example by soldering or integrally forming) and perpendicular thereto.

Circuit boards 100 and 200 are mounted to the frame 300 respectively by fasteners such as bolts, screw, etc. The larger circuit board 100 is mounted to the frame 300 with one side attached to the third body 360 and another side attached to the second body 340, whereas the smaller circuit board 200 is only mounted to the third body 360. The respective sides of the circuit boards 100 and 200 without electronic elements face the panel 400. Openings 362 and 364 are provided on the third body 360 to accommodate a power connector 120 of the first circuit board 120 and a signal adapter 220 of the second circuit board 200.

Shields 600 and 700 can be secured to the frame 300 to shield the circuit boards 100 and 200 respectively from electromagnetic interference.

If maintenance or replacement of electronic components on the circuit boards 100 and 200 is desired, the circuit boards 100 and 200 can be accessed only by removing the shield elements 600 and 700 without dissembling the panel 400 from the display, whereby the operation of maintenance or replacement can be simplified. In such a structure, only the position of the openings 362 and 364 on the third body 360 have to be modified for different designs, whereas the second body 340 can be used without any modification as long as the panel has the same size, thereby reducing the cost incurred by manufacturing different frames.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1-9. (canceled)

10. A method of assembling a circuit board to a display panel of a display device, comprising the steps of:
providing a frame comprising a first body and a second body perpendicularly connected to the first body;
securing the frame to the display panel; and
assembling the circuit board to the frame.

11. The method as claimed in claim 10, wherein the frame further comprises a third body separated from the first body by a predetermined distance.

12. The method as claimed in claim 11, wherein the method further comprises a step of:
coupling the circuit board to the first body.

13. The method as claimed in claim 12 further comprising a step of: assembling the circuit board to the first body via the second body.

14. The method as claimed in claim 11, wherein the method further comprises a step of:
securing the circuit board to the first and the third body.

15. The method as claimed in claim 10 further comprising a step of: securing a shield to the frame to cover the circuit board.

16. A display device, comprising:
a display panel;
a frame mounted on the display panel and comprising a first body and a second body perpendicularly connected to the first body; and
a circuit board coupled to the frame.

17. The display device as claimed in claim 16, wherein the circuit board is coupled to the first body.

18. The display device as claimed in claim 17, wherein the circuit board is coupled to the first body via the second body.

19. The display device as claimed in claim 16, the frame further comprises a third body separated from the first body by a predetermined distance.

20. The display device as claimed in claim 19, wherein the circuit board is coupled to the first and third bodies.

21. The display device as claimed in claim 16 further comprising a shield contacting the frame and covering the circuit board.

22. A display device, comprising:
a display panel;
a frame joined to opposite edges of the display panel; and
a circuit board coupled to the frame, wherein one side of the circuit board exposed to the frame.

23. The display device as claimed in claim 22, wherein the frame comprises a first body and a second body connected and perpendicular to the first body and a third body separated from the first body by a predetermined distance.

24. The display device as claimed in claim 23, wherein the circuit board is coupled to the first body.

25. The display device as claimed in claim 24, wherein the circuit board is coupled to the first body via the second body.

26. The display device as claimed in claim 23, wherein the circuit board is coupled to the first and third bodies.

27. The display device as claimed in claim 22, wherein the display device is applied to TV or monitor or notebook.
